(19) United States
(12) Patent Application Publication
(10) Pub. No.: US 2009/0226250 A1
(43) Pub. Date: Sep. 10, 2009

(54) ROTARY COUPLING DEVICE

(76) Inventors: Yves Cambot Courrau, Rennes (FR); Philippe Guillard, Betton (FR); Philippe Le Quere, Betton (FR)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 12/420,946

(22) Filed: Apr. 9, 2009

(30) Foreign Application Priority Data
Oct. 19, 2006 (FR) 0609172
Oct. 17, 2007 (FR) PCT/FR07/01712

(51) Int. Cl. F16D 1/05; F16L 27/08

(52) U.S. Cl. 403/408.1; 403/75

(57) ABSTRACT

A coupling device for coupling a first duct to a second duct, the device including first and second tubular elements, each having a coupling segment for coupling respectively to the first duct and to the second duct, and the coupling segments being linked together by link segments that are assembled together to be free to turn relative to each other, the link segment of the first element comprising a tubular male portion that is elastically deformable in a radial direction and that is engaged by force in a female portion of the link segment of the second element that is rigid relative thereto, and the coupling device including a third element that defines a fluid passage and that is received in the male portion to oppose radial deformation thereof.

### CROSS-REFERENCE TO RELATED CASES

This application is continuation of copending International Application No. PCT/FR07/001,712 filed Oct. 17, 2007, which designated the United States, and which claims priority to French Patent Application 0609172, filed Oct. 19, 2006, the disclosure of each of which is expressly incorporated herein by reference.

### BACKGROUND OF THE INVENTION

The present invention relates to a coupling device for coupling a first duct to a second duct, and suitable for use in circuits for conveying fluids such as hydraulic or pneumatic circuits, for coupling members of such a circuit such as fluid delivery or receiver members, together with pipes, manifolds, actuators, pumps, filters, for example.

Coupling devices exist that comprise first and second tubular elements, each having a coupling segment for coupling respectively to the first duct and to the second duct, the coupling sequentially linked together by link segments that are assembled together so as to be free to turn relative to each other. By way of example, the coupling segment of the first element comprises means for quick or lockable connection to the first duct. By way of example, the coupling segment of the second element is provided with a thread for engaging in a tapped end of the second duct. The two link segments are generally male and female and they are elastically deformable in a radial direction so as to be capable of co-operating with each other by snap-fastening or resilient engagement. The ability of the link segments to turn relative to each other enables the first duct to be oriented relative to the second duct after the second element has been screwed into the second duct. Such freedom to turn is also advantageous when the two ducts are free to move relative to each other. Freedom to turn then limits the mechanical stresses exerted on the link segments of the first and second elements of the coupling device, limiting any risk of fatigue stresses arising that could lead to rupture.

Snap-fastening the link segments together offers the advantage of enabling the two elements to be assembled together quickly and simply. Nevertheless, because of the deformability of the link segments, it presents the drawback of coming undone when subjected to forces that are relatively quite small.

It would therefore be advantageous to have a coupling device that is strong, while nevertheless having elements that are snap-fastened together.

### SUMMARY OF THE INVENTION

To this end, the invention provides a coupling device for coupling a first duct to a second duct, the device comprising first and second tubular elements, each having a coupling segment for coupling respectively to the first duct and to the second duct, the coupling segments being linked together by link segments that are assembled together to be free to turn relative to each other, the link segment of the first element comprising a tubular male portion that is elastically deformable in a radial direction and that is engaged by force in a female portion of the link segment of the second element that is rigid relative thereto, and the coupling device including a third element that defines a fluid passage and that is received in the male portion to oppose radial deformation thereof.

Thus, only the male portion deforms to enable the first element to be snap-fastened to the second element, and the third element serves to support the male portion after snap-fastening in such a manner as to prevent the first element from separating from the second element.

In a first embodiment, the third element is a split ring received in an internal groove of the male portion, or, in a variant, the third element is a split bushing.

This embodiment is particularly simple.

In a second embodiment, the third element is a tubular sheath and, preferably, the sheath has an end portion secured to the second element and an end portion pivotally received in the male portion.

The sheath thus stiffens not only the link segments of the first element, but also the second element. This improves the axial stiffness of the assembly formed by the first element and the second element.

Advantageously, according to a particular feature, the coupling segment of the second element is externally threaded for engagement into a tapped end of the second duct.

Once assembled, the coupling device is in the form of a unitary assembly that needs merely to be screwed into the second duct in order to be made operational and ready to receive the first duct.

According to another particular feature, the third element comprises a stiffener section engaged in the male portion, an intermediate section extending in the coupling segment of the second element, and an anchor section projecting from said coupling segment to be anchored in the second duct, and, preferably, the anchor section of the third element is threaded for engagement in a tapped end of the second duct, and the intermediate section preferably has an outside surface of non-circular outline.

Coupling between the coupling segment of the second element and the second duct is then provided via the third element.

Then, in a third embodiment, the intermediate section and the coupling segment of the second element have complementary portions in relief providing elastic retention therefore.

The snap-fastening of the second element to the intermediate section of the third element enables these two elements to be assembled together simply and quickly.

In a fourth embodiment, the intermediate section is welded in the coupling segment of the second element.

Welding provides strong bond between the third element and the second element.

In a fifth embodiment, the stiffener section and the first element include complementary portions in relief providing them with mutual elastic retention, and the third element and the first element include shoulders for retaining the second element between them.

The second element is then held captive between the first element and the third element that are snap-fastened to each other.

Other characteristics and advantages of the invention should appear on reading the following description of particular, non-limiting embodiments of the invention.

### BRIEF DESCRIPTION OF THE DRAWINGS

Reference is made to the accompanying drawings, in which:

FIG. 1 is a cutaway perspective view of a coupling device in accordance with a first embodiment of the invention;

FIG. 2 is a fragmentary section view on plane II-II of FIG. 1 showing the coupling device;

FIG. 3 is a view analogous to the view of FIG. 2, showing a coupling device constituting a variant of the first embodiment;

FIG. 4 is a view analogous to the view of FIG. 2, showing a coupling device in accordance with a second embodiment;

FIG. 5 and FIG. 6 are views analogous to FIG. 2 of coupling devices respectively constituting a third embodiment and a variant thereof; and

FIG. 7 and FIG. 8 are views analogous to the view of FIG. 2 showing coupling devices respectively in accordance with fourth and fifth embodiments.

The drawings will be described further in connection with the following Detailed Description of the Invention.

### DETAILED DESCRIPTION OF THE INVENTION

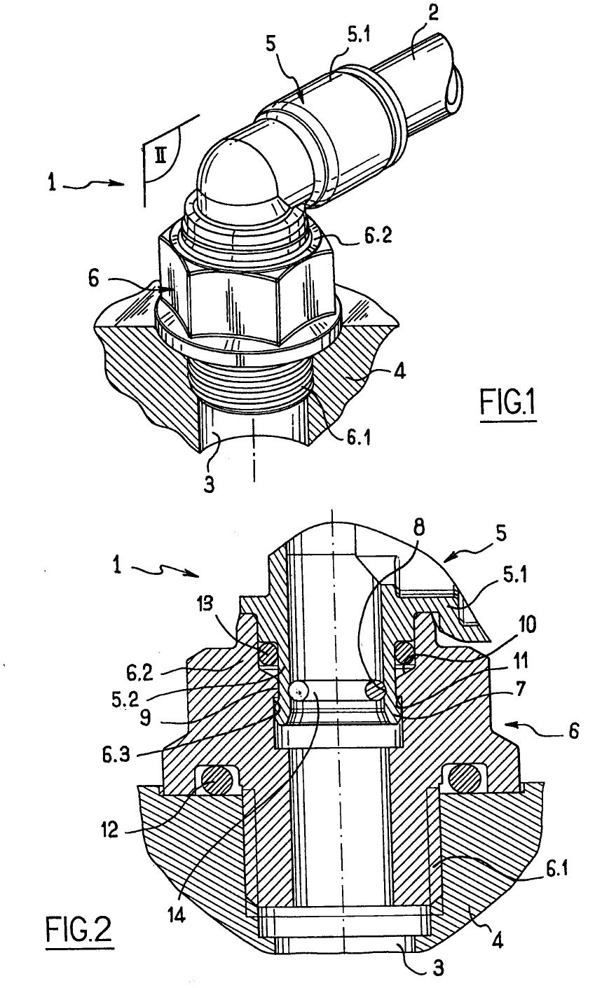

With reference to FIGS. 1 and 2, the coupling device in accordance with the first embodiment given overall reference 1 is arranged to enable a first duct, here a pipe 2, to be coupled to a second duct, here a channel 3 in a fluid-delivery or fluid-receiver circuit member 4. The channel 3 has a tapped end. Nevertheless, this end could be smooth and/or could include a groove.

The coupling device 1 comprises a first element 5 and a second element 6.

The first element 5 and the second element 6 are tubular.

The first element 5 comprises a coupling segment 5.1 for coupling to the pipe 2 and a link segment 5.2 for linking to the second element 6.

The coupling segment 5.1 includes known elements enabling it to be secured in leak-tight manner to one end of the pipe 2. These means are lockable or quick-connection means that are themselves known, e.g. comprising a tooth and deformable catch washer or a radially movable latch. Other leak-tight securing means can also be envisaged.

The link segment 5.2 extends perpendicularly to the coupling segment 5.1 and has a free end provided on the outside with a band or bead 7 having a frustoconical front face. The link segment 5.2 thus forms a male portion. A groove 8 is formed inside the male portion 5.2, set back from the bead 7. The male portion 5.2 is elastically deformable in a radial direction.

The second element 6 comprises a coupling segment 6.1 for coupling to the channel 3 and a link segment 6.2 for linking to the first element 5.

The coupling segment 6.1 has an outside thread so as to be capable of co-operating with the tapped end of the channel 3 by screw-fastening. The link segment 6.2 has a housing 6.3 arranged to form a female portion for receiving the male portion 5.2 of the first element 5. The inlet of the female portion 6.3 is provided internally with an inwardly-projecting annular step 9 presenting a front face 10 of frustoconical shape and a radial rear face forming a shoulder 11. The annular step 9 defines a passage of diameter smaller than the outside diameter of the bead 7. The female portion of the link segment 6.2 of the second element 6 is more rigid than the male portion 5.2 of the first element 5. The link segment 6.2 shown has an external shape of hexagonal section to make it easier to screw the coupling segment 6.1 into the channel 3.

The second element 6 is also fitted with annular sealing elements 12 and 13 for providing sealing firstly between the second element 6 and the circuit member 4, and secondly between the second element 6 and the first element 5.

A third element 14, here a split ring, is received in the groove 8 to form a stiffener member opposing radial deformation of the male portion of the first element.

The male portion 5.2 of the first element 5 is engaged elastically, or snap-fastened, in the female portion 6.3 of the link segment 6.2 of the second element 6. During snap-fastening, the front face of the bead 7 of the male portion and the front face 10 of the annular step 9 of the female portion come into contact and slide one on the other, causing the male portion to deform radially and enabling the bead 7 to pass through the passage defined by the annular step 9. Once the bead 7 has passed through, the male portion returns elastically to its rest state and the shoulder 11 of the annular step 9 opposes extraction of the male portion from the female portion.

Since the female portion of the link segment 6.2 of the second element 6 is more rigid than the male portion 5.2 of the first element 5, only the male portion 5.2 deforms during snap-fastening or extraction of the first element 5 from the second element 6.

The first element 5 and the second element 6 possess shoulders that, when in contact with each other, form an abutment against the male portion being pushed into the female portion. When these shoulders are in abutment, the groove 8 is in register with the annular step 9.

The third element 14 is put into place in the groove 8 after the first element 5 has been snap-fastened in the second element 6 and before screwing the second element 6 into the tapped end of the channel 3. The third element 14 is received only in the first element and it does not prevent the first element 5 from turning relative to the second element 6. The third element thus leaves the first element 5 free to turn relative to the second element.

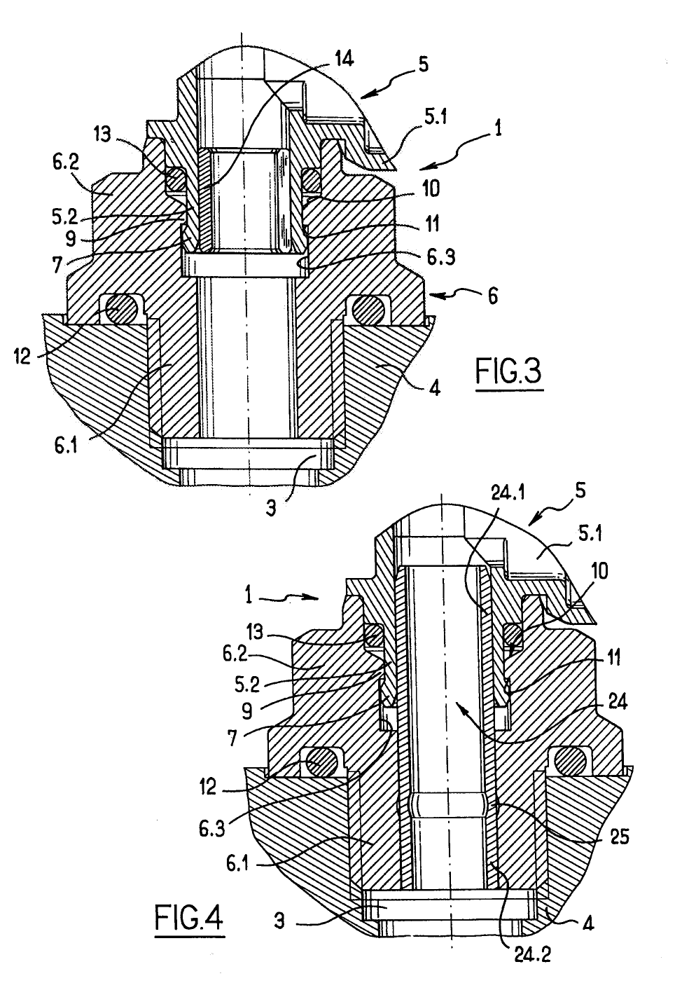

In a variant, as shown in FIG. 3, the third element 14 is a split bushing engaged by force in the male portion of the link segment 5.2 of the first element 5. In this embodiment, the male portion 5.2 does not have a groove for receiving the split bushing. Nevertheless, a groove could be provided.

The second embodiment of the coupling device, as shown in FIG. 4, differs from the first embodiment of the coupling device in that the third element, referenced 24, is a sheath having an end portion 24.1 received to turn freely in the male portion 5.2 of the first element 5 so as to form a stiffener member that opposes radial deformation thereof, and a second end 24.2 that projects from the male portion of the first element 5 into the second element 6 and that is secured to the coupling segment 6.1 of the second element 6. The third element 24 is secured to the second element 6 by a forced-fit engagement. For this purpose, the end 24.2 is provided with an external bulge 25 for locally increasing friction between the third element 24 and the second element 6. The end portion 24.1 that is received free to rotate in the first element 5 enables the first element 5 to pivot freely relative to the second element.

The third, fourth, and fifth embodiments are described below with reference to FIG. 5 to 8.

In these embodiments, the second element 6 has its coupling segment 6.1 merely bearing in leak-tight contact against a face of the member 4.

The third element 34 comprises a stiffener section 34.1 received to turn freely in the male portion 5.2 of the first element 5, an intermediate section 34.2, and an anchor section 34.3 that has an outside thread for engaging in the tapped end of the channel 3 of the member 4. The third element 34 does not hinder the first element turning relative to the second element.

In the third embodiment shown in FIG. 5, the coupling segment 6.1 of the second element 6 is provided internally with an annular step 35 and the intermediate section 34.2 of the third element 34 has outwardly-projecting tabs 36 made by cutting the wall forming the third element 34 so as to catch behind the annular step 35 of the coupling segment 6.1 of the second element 6 when the third element 34 is in position in the second element 6 and the first element 5. The annular face of the annular step 35 in contact with the tabs 36 is a radial shoulder providing non-separable assembly of the third element in the second element. The annular step 35 of the second element 6 has a transverse outline of shape complementary to that of the intermediate section so that they are constrained together in rotation.

Here the third element 34 is made of metal.

The coupling device in accordance with the third embodiment is assembled as follows. The male portion 5.2 of the first element 5 is snap-fastened in the female portion 6.2 of the second element 6, and then the third element 34 is snap-fastened in the second element 6. In a variant, the third element 34 is then screwed into the tapped end of the channel 3.

In a variant, the third element 34 may be screwed to the member 4 before being snap-fastened in the second element 6 snap-fastened to the first element 5. It should be observed that the intermediate section 34.2 preferably has an outside surface of non-circular outline, e.g. a polygonal surface, so as to enable a tool to be used to tighten the screw-fastening of the third element 34 in the tapped end of the channel 3.

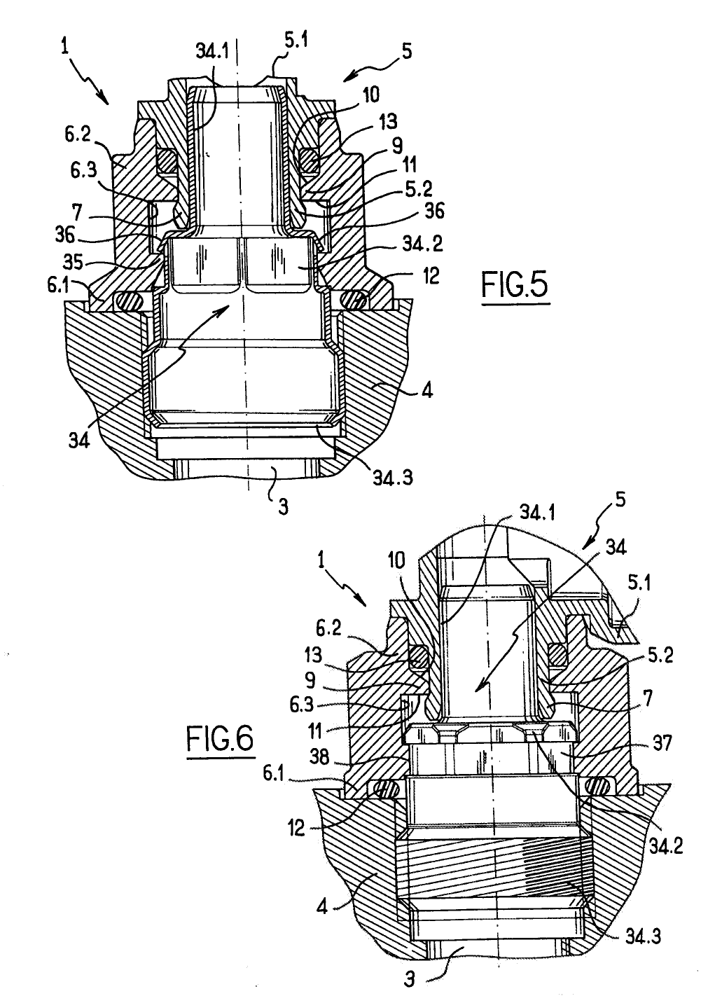

In another variant, shown in FIG. 6, the intermediate section 34.2 of the third element 34 may include setbacks 34, e.g. obtained by plastic deformation, serving to receive internal projections 38 of the coupling segment 6.1 of the second element 6.

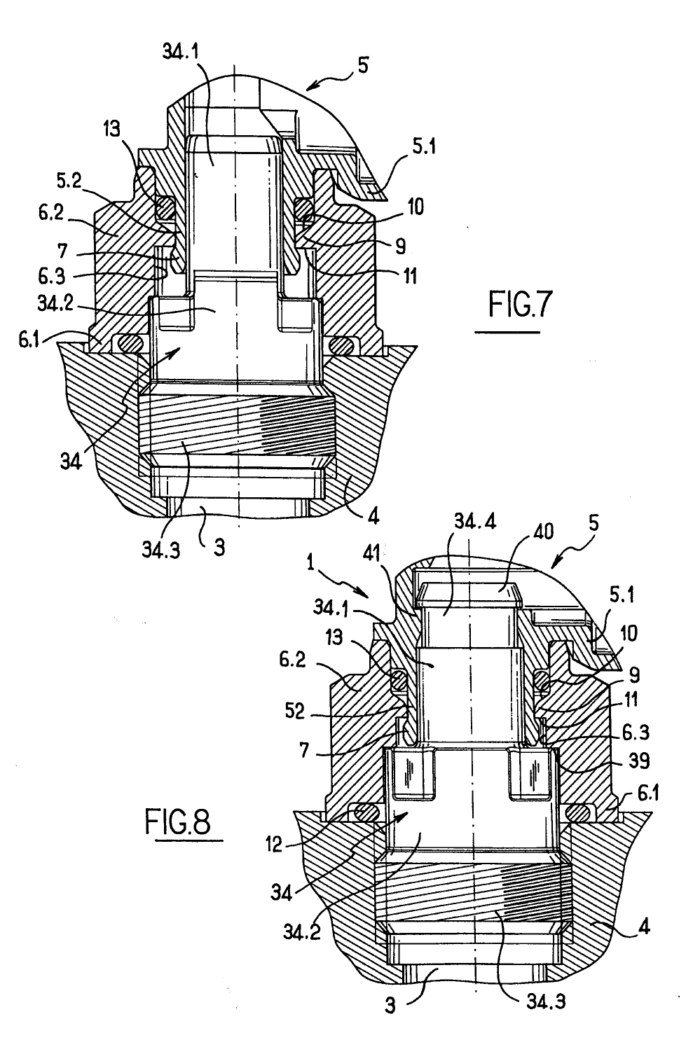

The coupling device in accordance with the fourth embodiment, shown in FIG. 7, differs from the third embodiment in that the intermediate section 34.2 of the third element 34 is welded in the coupling segment 6.2 of the second element 6. Here the welding is friction welding. In this embodiment, the first element 5 is assembled on the second element 6, and then the third element 34 is welded in the second element 6. The anchor section 34.3 of the third element 34 can then be screwed into the tapped end of the channel 3.

In the fifth embodiment of the coupling device, as shown in FIG. 8, the intermediate section 34.2 of the third element 34 is in abutment against an internal shoulder 39 of the second element 6 and the stiffener section 34.1 is extended by a snap-fastener section 34.4 having a terminal bead 40 of diameter greater than the diameter of a passage defined by an internal annular step 41 of the first element 5. Thus, the third element 34 is snap-fastened in the first element 5 and the second element 6 is held captive between the first element 5 and the third element 34.

In this embodiment, the first element 5 is initially snap-fastened to the second element 6, and the third element 34 is screwed into the tapped end of the channel 3. The assembly formed by the first element 5 and the second element 6 is then engaged on the third element 34 until the bead 40 of the snap-fastener section 34.4 has gone past the annular step 41.

In a variant, the third element 34 and the second element 6 may be constrained together in rotation.

Naturally, the invention is not limited to the embodiments described and embodiment variants can be applied thereto without going beyond the ambit of the invention as defined by the claims.

In particular, it is possible to make a coupling device by combining the various embodiments described.

The anchor section of the third element 34 may be arranged to be inserted by force or to be cramped in a smooth end of the channel 3.

The coupling segment 6.1 of the second element 6 may be arranged to receive a pipe end.

The third element may have any other shape serving to stiffen the male portion 5.2.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A coupling for connecting a first fluid duct to a second fluid duct, the coupling having a fluid passageway therethrough and comprising:
a generally tubular first member extending intermediate a first coupling end for connection to the first duct and a male end portion which is radially elastically deformable;
a generally tubular second member extending intermediate a second coupling end for connection to the second duct and a generally rigid female end portion, the male end portion of the first member being inserted coaxially into the female end potion of the second member and interferingly retained therein such that each of the first and the second member is rotatable relative to the other one of the first and the second member, and the male end portion of the first member being radially elastically deformed upon being inserted into the female end portion; and
a generally annular third member received coaxially in the male end portion of the first member following the insertion thereof into the female end portion of the second member and prior to the connection of the second coupling end of the second member to the second duct, the third member defining a portion of the fluid passage therethrough and delimiting the radial deformation of the male end portion of the first member.

2. The coupling of claim 1 wherein:
the female end portion of the second member has a radially inwardly extending internal step; and
the male end portion of the first member has a radially outwardly extending bead which interferingly engages the internal step of the female end portion of the second member retaining the male end portion of the first member in the second member.

3. The coupling of claim 1 wherein:
the male end portion of the first member has an internal groove; and
the third member is a split ring, the ring being received in the internal groove of the male end portion of the first member.

4. The coupling of claim 1 wherein the third member is a split bushing which is force fit into the male end portion of the first member.

5. The coupling of claim 1 wherein the third member is a generally tubular sleeve having a first sleeve end which is rotatably received in the male end portion of the first member and a second sleeve end extending therefrom which is force fit into the second coupling end of the second member.

6. The coupling of claim 1 wherein the third member is a generally tubular sleeve having a first sleeve end which is rotatably received in the male end portion of the first member, a second sleeve end extending from the second coupling end of the second member, the second sleeve end being connectable to the second duct, and an intermediate portion between the first and the second sleeve end received in the second coupling end of the second member.

7. The coupling of claim 6 wherein the second duct is internally threaded and the second sleeve end is externally threaded for a threaded connecting engagement with the second duct.

8. The coupling of claim 6 wherein:
the second coupling end of the second member has a radially inwardly extending internal step; and
the sleeve intermediate portion has a one or more radially outwardly extending tabs which interferingly engage the internal step of the second coupling end of the second member retaining the third member in the second member.

9. The coupling of claim 6 wherein:
the second coupling end of the second member has one or more radially inwardly extending internal projections; and
the sleeve intermediate portion has one or more external reliefs which each receives a complementary one of the internal projections of the second member retaining the third member in the second member.

10. The coupling of claim 6 wherein:
the male end portion of the first member has a radially inwardly extending internal step;
the first sleeve end has a radially outwardly extending external bead step which interferingly engages the internal step of the male end portion of the first member retaining the third member in the first member; and
the second coupling end of the second member has a radially inwardly extending internal step, the sleeve intermediate portion abuttingly engaging the internal step of the second coupling end of the second member thereby retaining the second member between the first member and the sleeve.

11. The coupling of claim 1 wherein the second duct is internally threaded and the second coupling end of the second member is externally threaded for a threaded connecting engagement with the second duct.

12. A method of assembling a coupling for connecting a first fluid duct to a second fluid duct, the coupling having a fluid passageway therethrough, and the method comprising the steps of:
(a) providing a generally tubular first member extending intermediate a first coupling end for connection to the first duct and a male end portion which is radially elastically deformable;
(b) providing a generally tubular second member extending intermediate a second coupling end for connection to the second duct and a generally rigid female end portion;
(c) inserting the male end portion of the first member coaxially into the female end potion of the second member, the male end portion of the first member being radially elastically deformed upon being inserted into the female end portion, and the male end portion being interferingly retained within the female end portion such that each of the first and the second member is rotatable relative to the other one of the first and the second member; and
(d) receiving a generally annular third received coaxially in the male end portion of the first member following the insertion thereof into the female end portion of the second member and prior to the connection of the second coupling end of the second member to the second duct, the third member defining a portion of the fluid passage therethrough and delimiting the radial deformation of the male end portion of the first member.

13. The method of claim 12 wherein:
the female end portion of the second member has a radially inwardly extending internal step; and
the male end portion of the first member has a radially outwardly extending bead which interferingly engages the internal step of the female end portion of the second member in step (c) retaining the male end portion of the first member in the second member.

14. The method of claim 12 wherein:
the male end portion of the first member has an internal groove; and
the third member is a split ring, the ring being received in step (d) in the internal groove of the male end portion of the first member.

15. The method of claim 12 wherein the third member is a split bushing which is force fit in step (d) into the male end portion of the first member.

16. The method of claim 12 wherein the third member is a generally tubular sleeve having a first sleeve end which is rotatably received in step (d) in the male end portion of the first member and a second sleeve end extending therefrom, the method comprising the additional step prior to or following step (d) of force fitting the sleeve end into the second coupling end of the second member.

17. The method of claim 12 wherein the third member is a generally tubular sleeve having a first sleeve end which is rotatably received in step (d) in the male end portion of the first member, a second sleeve end extending from the second coupling end of the second member, the second sleeve end being connectable to the second duct, and an intermediate portion between the first and the second sleeve end, the method comprising the additional step prior to or following step (d) of receiving the sleeve intermediate portion in the second coupling end of the second member.

18. The method of claim 17 wherein the second duct is internally threaded and the second sleeve end is externally threaded for a threaded connecting engagement with the second duct.

19. The method of claim 17 wherein:
the second coupling end of the second member has a radially inwardly extending internal step; and
the sleeve intermediate portion has a one or more radially outwardly extending tabs which in the additional step interferingly engage the internal step of the second coupling end of the second member retaining the third member in the second member.

20. The method of claim 17 wherein:
the second coupling end of the second member has one or more radially inwardly extending internal projections; and
the sleeve intermediate portion has one or more external reliefs which in the additional step each receives a complementary one of the internal projections of the second member retaining the third member in the second member.

21. The method of claim 17 wherein:
the male end portion of the first member has a radially inwardly extending internal step;
the first sleeve end has a radially outwardly extending external bead step which in step (d) interferingly engages the internal step of the male end portion of the first member retaining the third member in the first member; and
the second coupling end of the second member has a radially inwardly extending internal step, the sleeve intermediate portion in the additional step abuttingly engaging the internal step of the second coupling end of the second member thereby retaining the second member between the first member and the sleeve.

22. The method of claim 12 wherein the second duct is internally threaded and the second coupling end of the second member is externally threaded for a threaded connecting engagement with the second duct.
